(19) United States
(12) Patent Application Publication
(10) Pub. No.: US 2026/0287185 A1
(43) Pub. Date: Sep. 24, 2026

(54) HIGH PERFORMANCE VENTILATED WORKSPACES

(71) Applicant: 3Flow, Inc., Cary, NC (US)

(72) Inventors: Thomas C. SMITH, Raleigh, NC (US); Thomas W. SMITH, Raleigh, NC (US); Sean D. ANGLERT, Fort Mill, SC (US)

(21) Appl. No.: 19/574,402

(22) Filed: Mar. 22, 2026

Related U.S. Application Data
(60) Provisional application No. 63/776,451, filed on Mar. 24, 2025.

(51) Int. Cl. F24F 3/163

(52) U.S. Cl. CPC F24F 3/163

(57) ABSTRACT

A ventilated workspace includes a cabinet having a rear wall, a front wall, a floor, and opposing side walls that define an internal chamber. The front wall includes a chamber access opening, and the rear wall and side walls each include a plurality of openings configured to permit airflow from an external environment into the chamber. An air duct is externally mounted to the cabinet rear wall and side walls and includes a first open end portion and an opposite second open end portion. The air duct is in fluid communication with the plurality of openings such that air entering the first and second open end portions of the air duct can flow through the plurality of openings in the rear wall and side walls and into the chamber. A sash is slidably mounted at the access opening and is movable between raised and lowered positions.

### RELATED APPLICATION

This application claims the benefit of and priority to U.S. Provisional Patent Application No. 63/776,451 filed Mar. 24, 2025, the disclosure of which is incorporated herein by reference as if set forth in its entirety.

### FIELD OF THE INVENTION

The present invention relates generally to fume hoods and, more particularly, to fume hoods with reduced airflow and energy requirements.

### BACKGROUND OF THE INVENTION

Laboratory fume hoods are used to protect people working with hazardous airborne materials. A laboratory fume hood is defined as a box-like structure with typically one opening, where a sash or sashes move vertically or horizontally to close the opening. Typically, provisions are made for exhausting air from the top and back of the hood, and adjustable or fixed internal baffles are provided to obtain proper airflow distribution across the open face.

A conventional fume hood 10 is illustrated in FIGS. 1A-1C. The illustrated fume hood 10 includes a cabinet 12 having a ventilated work chamber 14 (i.e., the chamber 14 is in communication with an exhaust system 50 configured to draw air from the chamber 14). The chamber 14 has a rear wall 16, side walls 18, a ceiling 20, a floor 22 on which work is performed within the chamber 14, and an access opening 24 at the front of the chamber 14. A sash 26 is slidably mounted to the chamber 14 at the access opening 24 and is movable between raised (FIG. 1C) and lowered (FIG. 1B) positions. The sash 26 may consist primarily of a clear panel 27 so that users of the fume hood 10 can see into the chamber 14 through the clear panel 27. The sash 26 may also include a handle 28 for moving the sash 26 up and down in its vertical plane of movement. The sash 26 may engage a sill 30 when in the closed positioned. The chamber 14 also includes a baffle wall 40 located in front of the chamber rear wall 16. A lower gap 42 exists between a lower edge portion 40a of the baffle wall 40 and the chamber floor 22, and an upper gap 44 exists between an upper edge portion 40b of the baffle wall 40 and the chamber ceiling 20.

Conventional fume hoods can be constant air volume (CAV) fume hoods or variable air volume (VAV) fume hoods, and typically are equipped with a monitor configured to alert users when there is insufficient exhaust flow from the fume hood. For VAV fume hoods, the exhaust flow modulates from minimum flow when the sash is closed, or the hood is unoccupied, and the exhaust flow increases to maintain a specified average face velocity when the sash is open or occupied.

Containment performance for conventional fume hoods may be affected by numerous factors including the exhaust flow and average face velocity, the opening area, the baffle and bypass configuration, and internal airflow. Containment can also be affected by hood loading within the fume hood and external factors such as cross drafts, temperature stratification exterior to the hood, lab pressurization and other factors.

Conventional fume hoods typically have high exhaust flow requirements independent of the sash opening configuration that results in commensurately high energy costs, e.g., cost associated with electric motors and fans for creating airflow, etc. The required exhaust flow and resulting hood static pressure are directly related to the energy required to operate the fume hood. A traditional 6 foot wide, vertical sash VAV bench-top fume hood operating at face velocities between 60-fpm (feet per minute) and 100-fpm at a restricted vertical design opening (Af=7.85 ft²) would require an exhaust flow of 470 cfm (cubic feet per minute) to 785 cfm when the sash is open and approximately 250 cfm when the sash is closed. For example, at a typical cost of $5 per cfm-yr, a traditional VAV fume hood would cost approximately $1,525 per year to operate (annualized flow at 25% open and 75% closed sash=305 cfm×$5/cfm-yr).

Containment performance for traditionally designed laboratory fume hoods may be affected by a complex interaction of numerous variables such as how airflow enters the fume hood through the sash opening, the speed, direction and turbulence of the air velocities across the face opening and within the fume hood, and the internal airflow patterns where reverse flow and vortices within the hood interior can increase potential for escape. FIG. 2 illustrates airflow patterns AP and vortices V that typically occur in a conventional fume hood 10 downstream of a person standing at the opening of the fume hood chamber.

Conventional fume hoods may include components that influence internal airflow patterns and aerodynamics around the sash opening. For example, an airfoil that may be present above the work-surface, a bypass opening may be present where air enters the fume hood above the sash, and baffle panels and slots may be located at the back of the hood. Proper performance in terms of capture and containment of airborne hazards within conventional fume hoods can be affected by any of these components, and the flow patterns through the fume hood also effect the hood static pressure and total exhaust flow required for containment. Flow can be reduced when the sash is closed but the minimum acceptable flow is also affected and limited by internal airflow patterns where contaminants can be entrained in vortices within the hood enclosure reducing the ability to efficiently dilute and remove contaminants.

### SUMMARY OF THE INVENTION

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

According to some embodiments of the present invention, a ventilated workspace includes a cabinet having a rear wall, a front wall, a floor, and opposing side walls that define an internal chamber. The front wall includes a chamber access opening, and the rear wall and side walls each include a plurality of openings (e.g., openings in adjacent, spaced-apart relationship) configured to permit airflow from an external environment into the chamber. An air duct is externally mounted to the cabinet rear wall and side walls and includes a first open end portion and an opposite second open end portion. The air duct is in fluid communication with the plurality of openings in the rear wall and side walls such that air entering the first and second open end portions of the air duct can flow through the plurality of openings in the rear wall and side walls and into the chamber.

A sash is slidably mounted to the cabinet at the access opening and is movable between raised and lowered positions. In some embodiments, the sash is movable between raised and lowered positions along a non-vertical direction (i.e., the sash is angled relative to vertical). In some embodiments, the sash is located external to the cabinet. In some embodiments, at least one horizontally sliding panel is at the access opening and is configured to cover and uncover portions of the access opening. At least a portion of the at least one horizontally sliding panel is transparent. In some embodiments, the cabinet may include a sash sensor configured to determine a current position of the sash and/or a sash sensor configured to determine a current position of the at least one horizontally sliding panel.

In some embodiments, the duct extends around the cabinet such that the first open end portion of the air duct is located adjacent to one side of the cabinet front wall and the opposite second open end portion of the air duct is located adjacent to an opposite side of the cabinet front wall.

In some embodiments, an airflow monitor is at one or both of the first and second open end portions of the air duct and is configured to measure an amount of airflow into the chamber.

In some embodiments, the ventilated workspace may include one or more service panels secured externally (e.g., removably secured) to the cabinet. Each service panel provides one or more of the following for the ventilated workspace: air supply from an air source, gas supply from a gas source, vacuum from a vacuum source, and electrical service from an electrical source. The one or more service panels may be externally mounted to one of the side walls.

In some embodiments, the ventilated workspace may include a monitor within the chamber that is configured to measure airflow and air pressure within the chamber.

The upper portion of the chamber is configured to be connected to an exhaust system having a fan and an exhaust duct. In some embodiments, the chamber may include a sensor that is configured to detect contaminants in air exiting the chamber through the exhaust system. In some embodiments, the chamber may include airflow guide vanes that are configured to facilitate vertical airflow from the chamber into the exhaust system. In some embodiments, the chamber may include at least one filter configured to capture contaminants from air flowing to the exhaust system.

In some embodiments, the cabinet of the ventilated workspace may include a scannable code (e.g., a barcode or a quick response (QR) code, etc.) configured to be scanned by a user device to obtain current and past operational information for the ventilated workspace. Types of operational information that may be obtained include, but is not limited to, one or more of the following: sash configuration information, information about a hazard within the chamber, surrounding room temperature, surrounding room pressure.

According to other embodiments of the present invention, a ventilated workspace includes a cabinet having a rear wall, a front wall, a floor, and opposing side walls that define an internal chamber. The front wall includes a chamber access opening, and the rear wall and side walls each include a plurality of openings configured to permit airflow from an external environment into the chamber. An air duct is externally mounted to the cabinet rear wall and side walls and includes a first open end portion and an opposite second open end portion. The air duct is in fluid communication with the plurality of openings in the rear wall and side walls such that air entering the first and second open end portions of the air duct can flow through the plurality of openings in the rear wall and side walls and into the chamber. A sash is slidably mounted to the cabinet at the access opening and is movable between raised and lowered positions. At least one service panel is secured externally (e.g., removably secured) to the cabinet and provides one or more of the following for the ventilated workspace: air supply from an air source, gas supply from a gas source, vacuum from a vacuum source, and electrical service from an electrical source.

In some embodiments, the ventilated workspace further includes at least one horizontally sliding panel at the access opening that is configured to cover and uncover portions of the access opening.

The upper portion of the chamber is configured to be connected to an exhaust system having a fan and an exhaust duct. In some embodiments, the chamber may include a sensor that is configured to detect contaminants in air exiting the chamber through the exhaust system. In some embodiments, the chamber may include airflow guide vanes that are configured to facilitate vertical airflow from the chamber into the exhaust system. In some embodiments, the chamber may include at least one filter configured to capture contaminants from air flowing to the exhaust system.

In some embodiments, the cabinet of the ventilated workspace may include a scannable code (e.g., a barcode or a quick response (QR) code, etc.) configured to be scanned by a user device to obtain current and past operational information for the ventilated workspace. Types of operational information that may be obtained include, but is not limited to, one or more of the following: sash configuration information, information about a hazard within the chamber, surrounding room temperature, surrounding room pressure, etc.

According to other embodiments of the present invention, a ventilated workspace includes a cabinet having a rear wall, a front wall, a floor, and opposing side walls that define an internal chamber. The front wall includes a chamber access opening, and the rear wall and side walls each include a plurality of openings configured to permit airflow from an external environment into the chamber. An upper portion of the chamber is configured to be connected to an exhaust system having a fan and an exhaust duct. An air duct is externally mounted to the cabinet rear wall and side walls. The air duct includes a first open end portion and an opposite second open end portion and is in fluid communication with the plurality of openings in the rear wall and side walls such that air entering the first and second open end portions of the air duct can flow through the plurality of openings in the rear wall and side walls and into the chamber. A sash is slidably mounted to the cabinet at the access opening and is movable between raised and lowered positions. Airflow guide vanes are located within the chamber and are configured to facilitate vertical airflow from the chamber into the exhaust system.

In some embodiments, at least one horizontally sliding panel is at the access opening and is configured to cover and uncover portions of the access opening.

In some embodiments, at least one service panel is secured externally (e.g., removably secured) to the cabinet and provides one or more of the following for the ventilated workspace: air supply from an air source, gas supply from a gas source, vacuum from a vacuum source, and electrical service from an electrical source.

In some embodiments, a sensor is provided within the chamber that is configured to detect contaminants in air exiting the chamber through the exhaust system.

In some embodiments, the chamber may include at least one filter configured to capture contaminants from air flowing to the exhaust system.

In some embodiments, the cabinet of the ventilated workspace may include a scannable code (e.g., a barcode or a quick response (QR) code, etc.) configured to be scanned by a user device to obtain current and past operational information for the ventilated workspace. Types of operational information that may be obtained include, but is not limited to, one or more of the following: sash configuration information, information about a hazard within the chamber, surrounding room temperature, surrounding room pressure, etc.

It is noted that aspects of the invention described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail below.

### BRIEF DESCRIPTION OF THE DRAWINGS

The accompanying drawings, which form a part of the specification, illustrate various embodiments of the present invention. The drawings and description together serve to fully explain embodiments of the present invention.

FIG. 1A is a front view of a conventional laboratory fume hood.

FIG. 1B is a cross-sectional view of the fume hood of FIG. 1A taken along line 1B-1B.

FIG. 1C is a cross-sectional view of the fume hood of FIG. 1A taken along line 1C-1C.

FIG. 2 illustrates airflow patterns and vortices typically associated with conventional fume hoods, such as the fume hood of FIGS. 1A-1C.

FIG. 3A is a front view of a ventilated workspace, according to some embodiments of the present invention.

FIG. 3B is a side view of the ventilated workspace of FIG. 3A taken along line 3B-3B.

FIG. 4 is a side view of the ventilated workspace of FIG. 3A taken along line 4-4 and with the side wall removed to illustrate airflow patterns through and within the ventilated workspace, according to embodiments of the present invention.

FIG. 5A is a front, exploded view of a ventilated workspace with horizontal sliding safety shields, according to embodiments of the present invention.

FIG. 5B is a side view of the ventilated workspace of FIG. 5A taken along line 5B-5B.

FIGS. 6A-6B are front views of the ventilated workspace of FIG. 5A and illustrating the horizontal sliding safety shields in various positions.

FIG. 7A is a front view of a ventilated workspace with service panels attached to the side thereof, according to some embodiments of the present invention.

FIG. 7B is a side view of the ventilated workspace of FIG. 7A taken along line 7B-7B.

FIG. 8A is a front view of a ventilated workspace with advanced flow and contaminant sensing, airflow guide vanes with optional filtration modules, and electronic access to operational data using a Smart Phone or other device, according to some embodiments of the present invention.

FIG. 8B is a side view of the ventilated workspace of FIG. 8A taken along line 8B-8B.

FIGS. 9A-9C are side views of a ventilated workspace, according to some embodiments of the present invention, that illustrate a sash sensor and the impact of the vertical sash position on total exhaust flow.

FIGS. 10A-10C are front views of the ventilated workspace of FIGS. 9A-9C that illustrate the impact of the vertical sash position on total exhaust flow.

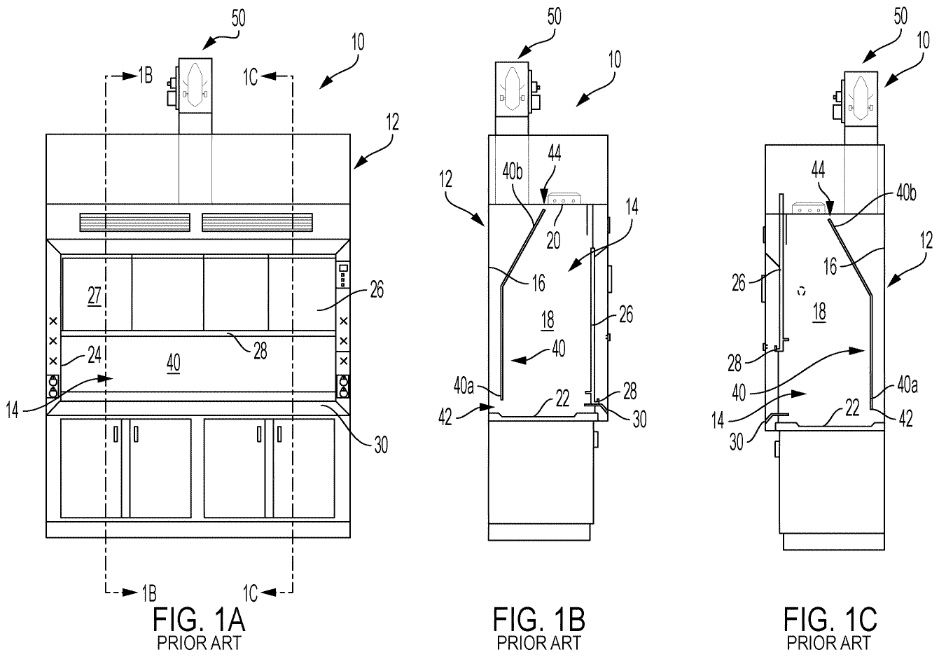

### DETAILED DESCRIPTION OF THE INVENTION

The present invention will now be described more fully hereinafter with reference to the accompanying figures, in which embodiments of the present invention are shown. The present invention may, however, be embodied in many different forms and should not be construed as limited to the embodiments set forth herein.

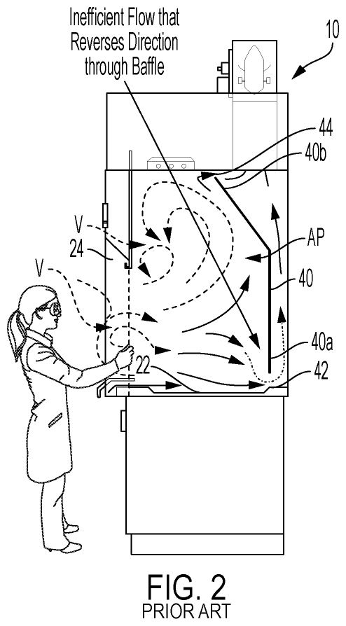

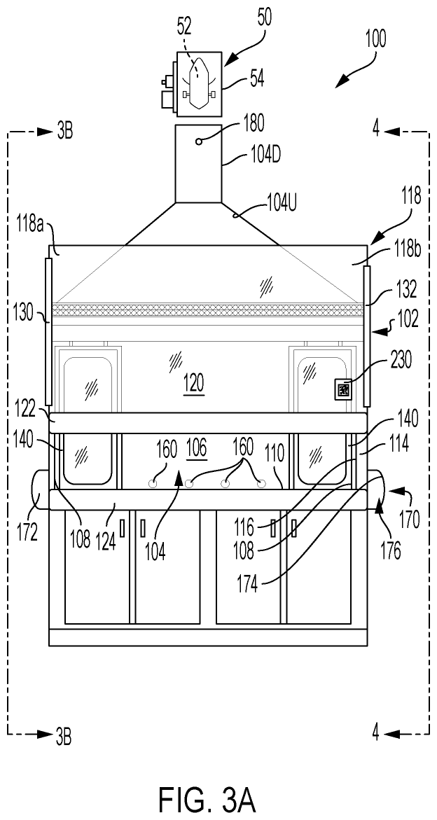

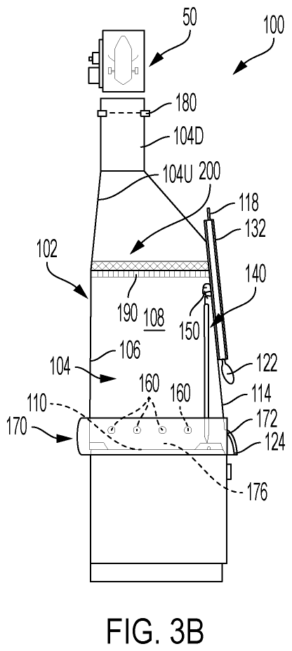

FIGS. 3A-3B illustrate a new ventilated workspace 100 that can outperform traditional fume hoods at significantly lower flow and energy consumption based on results of thousands of fume hood performance tests conducted in accordance with the ASHRAE 110 Method of Testing Performance of Laboratory Fume Hoods. The ventilated workspace 100 includes a variety of components to address the aerodynamic weaknesses in traditional fume hoods along with providing greater ability to enhance protection for a user of the ventilated workspace 100, monitor performance, and be more flexible to accommodate a wide range of applications, while minimizing exhaust flow and energy consumption.

The illustrated ventilated workspace 100 includes a cabinet 102 having a ventilated work chamber 104 (i.e., the chamber 104 is in communication with an exhaust system 50). The chamber 104 has a rear wall 106, side walls 108, a floor 110 on which work is performed within the chamber 104, an angled front wall 114, and an access opening 116 in the angled front wall 114. A sash 118 is slidably mounted to the front wall 114 at the access opening 116 and is movable between raised and lowered positions. Because the front wall 114 is angled, the sash 118 is moved between open and closed positions along a direction that is not vertical. The angled sash 118 improves aerodynamic entry conditions at the access opening 116 by reducing abrupt flow separation and localized turbulence at the access opening 116. The angled sash 118 also improves user ergonomics and visibility while helping guide inward airflow more smoothly into the chamber 104. In some embodiments, the sash 118 may be angled relative to vertical between about five degrees and about thirty degrees (5°-30°), although other angles are possible. Moreover, in other embodiments, the front wall 114 is not angled and the sash 118 is moved between open and closed positions along a substantially vertical direction.

In the illustrated embodiment, the sash 118 is externally mounted to the front wall 114 and consists primarily of a clear panel 120 formed of glass or any other desired material so that users of the ventilated workspace 100 can see into the chamber 104 through the clear panel 120. The illustrated sash 118 includes a handle 122 for moving the sash 118 between raised and lowered positions. The illustrated handle 122 has a streamlined, low-profile shape intended to minimize airflow disturbance at the access opening 116. The aerodynamic configuration of the sash handle 122 facilitates smooth, non-turbulent airflow inward into the chamber 104 when the sash is in an open position, and helps prevent reverse flow and vortices. Suitable configurations of the sash handle 122 include, but are not limited to, rounded, radiused, elliptical, teardrop, or similar aerodynamic cross sections.

The sash 118 is mounted to the front wall 114 via respective channel members 130, 132 that are each respectively secured to the front wall 114 on opposing sides of the access opening 116. One side edge portion 118a of the sash is moveably secured within channel member 130, and the opposite side edge portion 118b of the sash is moveably secured within channel member 132. The channel members 130, 132 are configured to hold the sash 118 when moved to any raised position.

The illustrated ventilated workspace 100 also includes an airfoil inlet vane 124 at the access opening 116 adjacent to the floor 110 of the chamber 104. The airfoil inlet vane 124 facilitates smooth, non-turbulent airflow inward into the chamber 104 when the sash is in an open position, and helps prevent reverse flow and vortices. The airfoil inlet vane 124 may have a radiused, curved, or streamlined profile. In some embodiments, more than one inlet vane may be utilized.

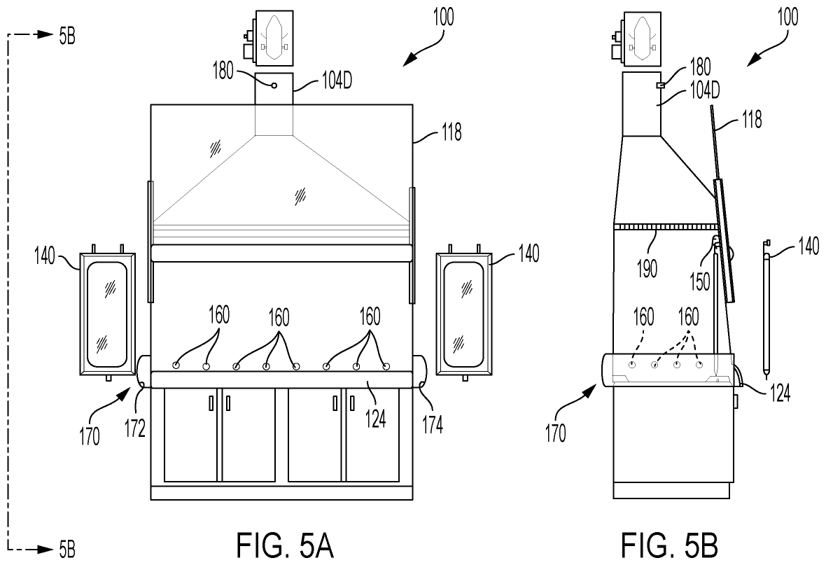

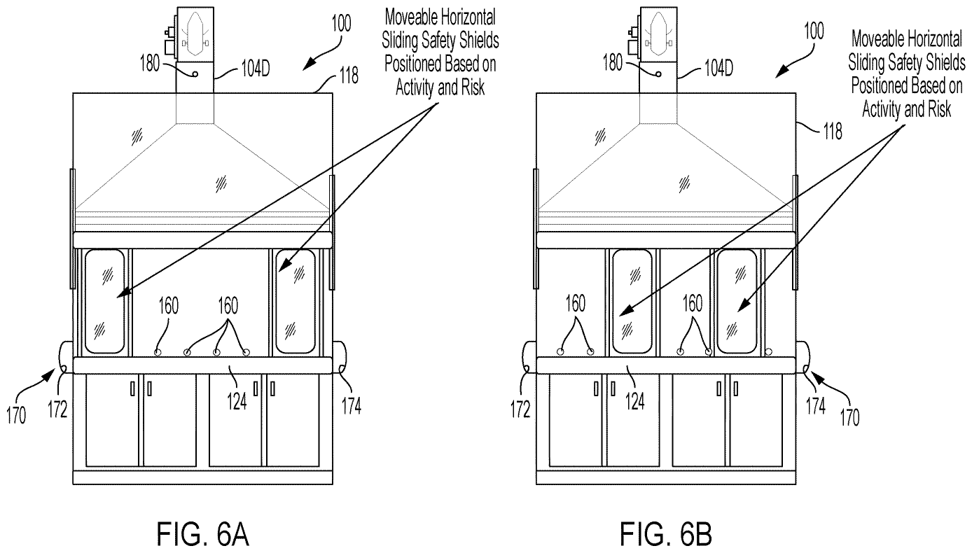

The illustrated ventilated workspace 100 also includes a plurality of horizontally sliding safety shields or panels 140 at the access opening 116 that are configured to cover and uncover portions of the access opening 116. At least a portion of each horizontally sliding panel 140 is transparent so that a user can view the chamber 104. The horizontal sliding panels 140 may be mounted interior of the sash 118 to enhance user safety and to limit the amount of the access opening 116 that is open when raising the sash 118. The horizontal sliding panels 140 can be moved or positioned as desired to support user activities. Example horizontal sliding panels 140 that may be utilized with embodiments of the present invention are described in U.S. Pat. No. 10,493,505, which is incorporated herein by reference, in its entirety. The panels 140 can also be removed with no loss of containment, as illustrated in FIGS. 5A-5B. Furthermore, a ventilated workspace 100 according to some embodiments of the present invention, does not require any horizontal sliding panels.

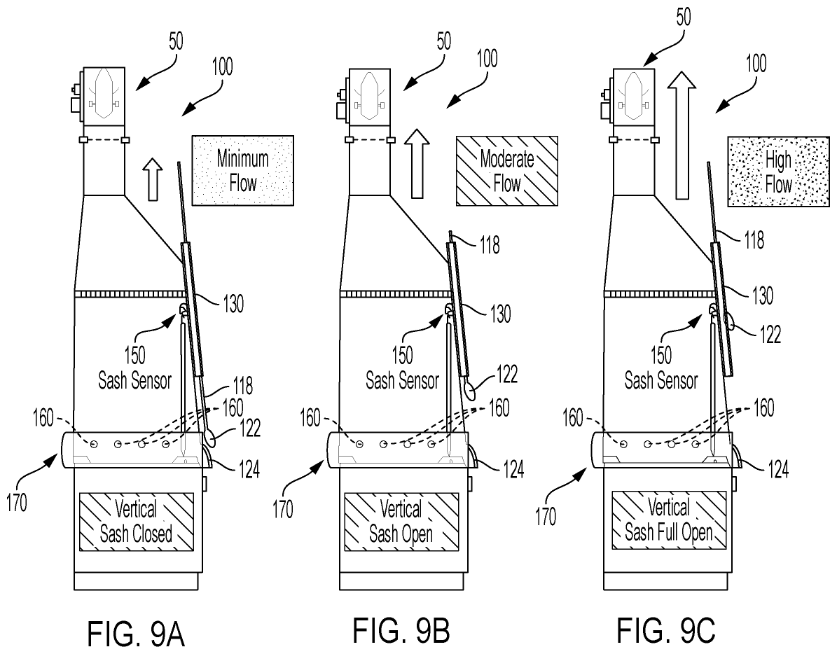

In some embodiments, as illustrated in FIGS. 9A-9C, the cabinet 102 may include a sash sensor 150 that is configured to determine a current position of the sash 118. The sash sensor 150 (or another sensor or group of sensors) may also be configured to determine a current position of each of the horizontally sliding panels 140. The sash sensor 150 can be used to track utilization of the ventilated workspace 100 or provide a signal for modulating flow in proportion to the opening area 116 or sash configuration. Various types of sensors may be utilized as the sash sensor 150. For example, sash position can be sensed with contact position devices such as string (cable) potentiometers, rotary or linear potentiometers, and rotary or linear encoders, which provide continuous analog or digital position signals. Non-contact or discrete devices such as inductive, mechanical, magnetic (reed or Hall), optical, or ultrasonic sensors can provide simple open/closed or zone-based indications, sometimes supplemented by airflow or pressure sensors that indirectly relate to sash position.

Referring back to FIGS. 3A-3B, the rear wall 106 and side walls 108 each include a plurality of openings 160 arranged in adjacent, spaced-apart relationship adjacent to the floor 110 of the chamber 104. The openings 160 are configured to permit airflow from an external environment into the chamber 104. Although illustrated as being circular, the openings 160 can have various shapes and are not limited to being circular. For example, the openings 160 may have a slotted, oval, or elongated configuration in some embodiments. In addition, although illustrated as being arranged in a single row, the openings 160 may be arranged in multiple rows and/or with aligned or staggered configurations. Opening size and spacing may vary depending on the size of the chamber 104 and intended airflow distribution. The openings 160 distribute inflow uniformly around the perimeter of the chamber 104 while avoiding concentrated jets that create turbulence or short circuit flow. In some embodiments, each opening may have an area of between about 0.05 in² and about 10 in². However, embodiments of the present invention are not limited to the openings 160 being within this range. Moreover, some openings 160 may have a different size and/or configuration from other openings 160, in some embodiments.

An air girdle or duct 170 is externally mounted to the cabinet rear wall 106 and side walls 108. The air duct 170 includes a first open end portion 172 and an opposite second open end portion 174 and a passageway 176 that extends between the first open end portion 172 and the second open end portion 174. The passageway 176 of the air duct 170 is in fluid communication with the plurality of openings 160 such that air entering the first and second open end portions 172, 174 of the air duct 170 can flow through the plurality of openings 160 and into the chamber 104. The first and second open end portions 172, 174 of the air duct 170 allow for local airflow measurement, balancing, inspection, or verification of airflow entering the perimeter air duct 170. These open end portions 172, 174 may also serve as access points for sensing or balancing during commissioning or operation of the ventilated workspace 100.

The air duct 170 can be formed from various materials, including polymeric materials, metals, coated metals, stainless steel, sheet metal, molded composite, fiberglass reinforced materials, or similar rigid construction materials. A cross sectional shape of the air duct 170 may be rectangular, rounded, oval, or otherwise configured to promote low pressure drop and uniform flow distribution. In the illustrated embodiment, the air duct 170 has a generally “U” shaped cross-section. The air duct cross sectional area is configured to distribute air uniformly to the perimeter openings 160 while maintaining low air resistance. In some embodiments, the cross sectional area of the air duct 170 may be in a range of from about one and a half square inches (1.5 in²) to about two hundred and thirty square inches (230 in²). However, embodiments of the present invention are not limited to this range. Moreover, in some embodiments, the cross sectional area of the air duct 170 may vary along its length between the open end portions 172, 174.

The upper portion 104U of the chamber 104 has a tapered configuration that converges to a discharge duct 104D, as illustrated in FIGS. 3A-3B. The discharge duct 104D is configured to be connected to an exhaust system 50. The exhaust system 50 includes a fan 52 and an exhaust duct 54 that is in fluid communication with an external environment, such as outdoors, and so that airflow from the chamber 104 is exhausted to the external environment. In the illustrated embodiment, an integrated airflow and pressure monitor 180 is located in the discharge duct 104D for measuring and reporting operating conditions of the chamber 104. The monitor 180 is configured to measure one or more of airflow, static pressure, differential pressure, temperature, or related operating parameters in the chamber 104. The monitor 180 may support local display, alarm indication, trend logging, remote communication, and control of workspace 100 operating modes including minimum flow, active use, and elevated demand conditions. The monitor 180 may also be in communication with a controller or controller system configured to modify airflow, static pressure, differential pressure, temperature, or related operating parameters in the chamber 104 of the workspace 100.

In some embodiments, the integrated airflow and pressure monitor 180 may include optical sensing, gas detection, contaminant detection, or hyperspectral sensing configured to detect contaminants in air exiting the chamber 104 through the exhaust system 50, as well as other process conditions within the chamber 104. Hyperspectral gas detection sensing may utilize similar technology as used in smart phone camera lenses to detect the presence of gas/vapor and aerosol contaminants in the exhaust. The exhaust flow and operating modes for the ventilated workspace 100 can be modified depending on the type and quantity of effluent. This enables minimum flow or hibernation modes when the workspace 100 is not in use to capture, contain or remove airborne contaminants.

In the illustrated embodiment, airflow guide vanes 190 are located within the chamber 104 at the transition with the upper portion 104U of the chamber 104. In the illustrated embodiment, the airflow guide vanes 190 are located within the entire area of the transition with the upper portion 104U of the chamber 104. For example, the airflow guide vanes 190 may have an elongated configuration that extend from the front wall 114 to the rear wall 106 and that are in adjacent spaced-apart relationship for the entire width of chamber between the sidewalls 108. Alternatively, the airflow guide vanes 190 may have an elongated configuration that extend from one side wall 108 to the opposite side wall 108 and that are in adjacent spaced-apart relationship for the entire width of chamber between front wall 114 and the rear wall 106.

The airflow guide vanes 190 are vertically oriented and configured to direct airflow vertically upward from the chamber 104 and into the exhaust system 50. The airflow guide vanes 190 help streamline the vertical flow of air through the chamber 104 and into the exhaust system 50. The airflow guide vanes 190 are configured to align upward airflow, reduce swirl, reduce reverse flow, and promote a more uniform vertical discharge pattern. The airflow guide vanes 190 may be fixed, removable, curved, planar, angled, or profiled, and may also support filter placement where applicable.

The openings 160 in the rear wall 106 and side walls 108 are located near the floor 110 of the chamber 104. For example, in some embodiments the openings 160 may be located between about one inch and twenty four inches (1″-24″) from the floor 110. However, embodiments of the present invention are not limited to this range. The openings 160 may be located more than twenty four inches (24″) and less than one inch (1″) from the floor 110 in other embodiments. The workspace design promotes airflow through the access opening 116 and around the perimeter sides and rear of the cabinet 102 through the airflow duct 170 and openings 160 to create an efficient, vertically upwards directed flow within the chamber 104 and through the airflow guide vanes 190 for exhaust to an external environment.

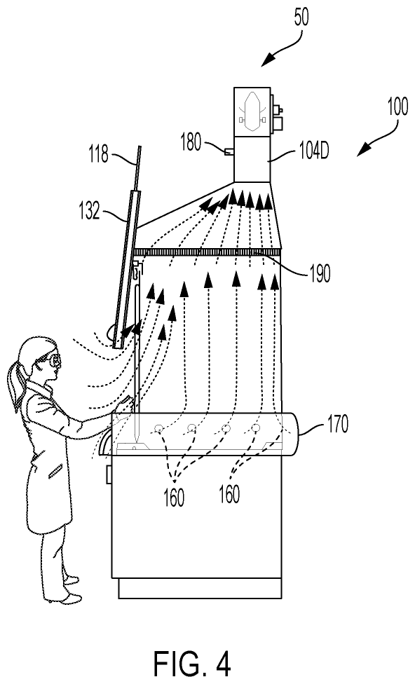

The airflow design of the ventilated workspace 100 is unique in the way airflow patterns flow upwards through the chamber 104, as illustrated in FIG. 4. The ventilated workspace 100 does not require traditional baffle and bypass panels for directing airflow patterns within the chamber 104. The upward flow of air, as illustrated in FIG. 4, maximizes contaminant capture, containment, dilution and removal at a total exhaust flow and hood static pressure that is significantly less than a traditional fume hood of the same size and approximate dimensions. Air flow enters through the access opening 116 and through the openings 160 in the sides and back of the cabinet 102 regardless of the sash 118 configuration.

The air flow patterns generated by the openings 160 in the side walls 108 and rear wall 106 prevent or reduce the reversal of air flow within the chamber 108. Moreover, the air flow patterns generated by the openings 160 in the side walls 108 and rear wall 106 greatly reduce or eliminate vortices and turbulence within the chamber 104. As such, contaminants within the chamber 104 can be contained, diluted and removed more efficiently than with conventional fume hoods and with lower air flow and pressure drop. This design of the workspace 100 also eliminates issues with internal heat loads that affect internal airflow patterns and that can devastate performance of traditional fume hood designs.

The illustrated chamber 104 also includes a filter 200 that is configured to capture contaminants prior to entering the exhaust system 50. In the illustrated embodiment, the filter 200 is located at the transition with the upper portion 104U of the chamber 104 and is positioned downstream from the airflow guide vanes 190. However, in other embodiments, the filter 200 may be positioned on the other side of the airflow guide vanes 190. In addition, more than one filter 200 and/or more than one filter type may be utilized. In some embodiments, the filter 200 may be a HEPA (High-Efficiency Particulate Air) filters are designed to capture fine particulate matter, such as dust, aerosols, and biological contaminants. In some embodiments, the filter 200 may be a carbon (activated charcoal) filter configured to adsorb chemical fumes and vapors. In some embodiments, the chamber 104 may utilize a combination of HEPA and carbon filters.

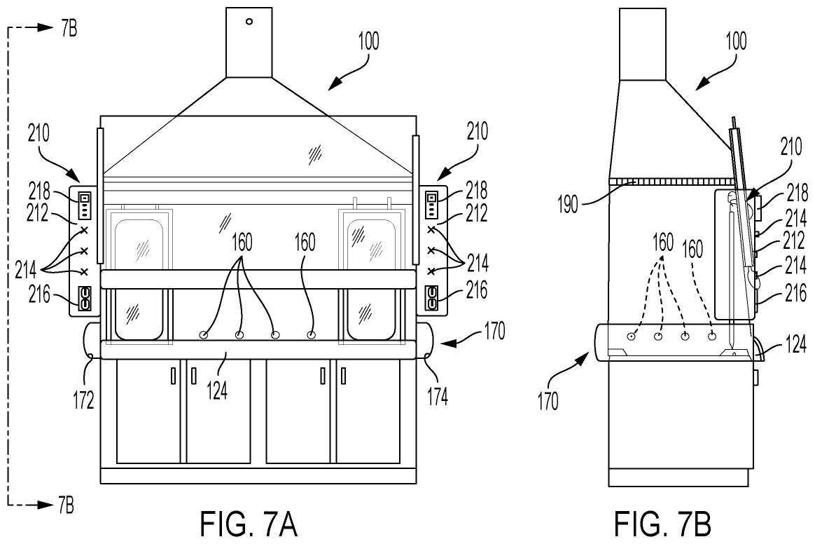

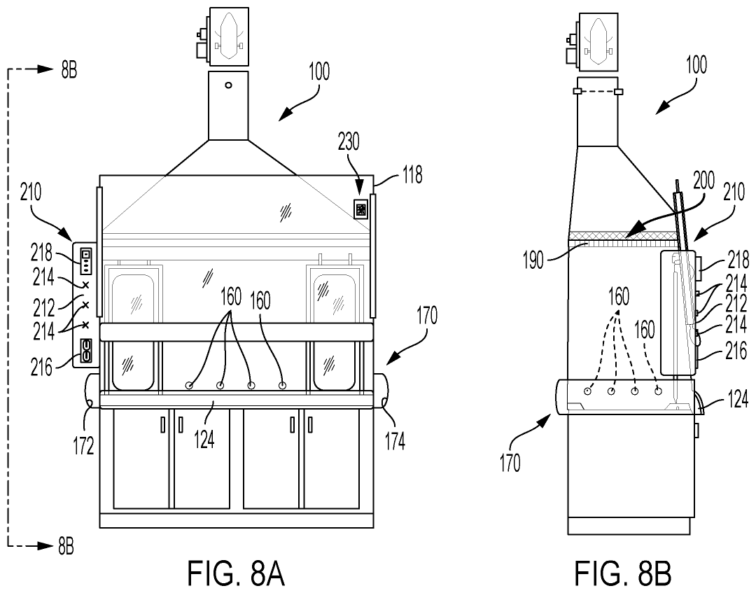

Referring to FIGS. 7A-7B and 8A-8B a service panel 210 may be mounted externally to the cabinet 102, for example, via a pin/groove or other mounting mechanisms that facilitate easy attachment and removal. The side service panels 210 are intended as modular utility access zones that may contain gas, vacuum, electrical, data, or fluid connections. In the illustrated embodiment, a service panel 210 is mounted to both of the side walls 108 and such that a front wall 212 of each service panel 210 is located adjacent the access opening 116 of the chamber 104. Because the service panels 210 are not integrated into the cabinet 102 of the workspace 100, the workspace 100 is less costly to manufacture than conventional fume hoods.

Each service panel 210 can be equipped or house a variety of services including hood monitors and controls, gas, air, vacuum valves, electrical outlets, etc. For example, each service panel 210 can provide one or more of the following: air supply from an air source, gas supply from a gas source (not shown), vacuum from a vacuum source (not shown), and electrical service from an electrical power source (not shown). The front wall 212 of each service panel 210 includes respective valves 214 for an air source, a gas source, and a vacuum source supplied into the chamber 104. A monitor 218 on each service panel 210 may serve as a local operating display, hood status monitor, airflow display, alarm indicator, or user interface. In addition, electrical service can be provided from an electrical power source via electrical outlets 216 in the front wall 212.

As illustrated in FIG. 3A, in some embodiments, the ventilated workspace 100 may include a scannable code 230 (e.g., a barcode, quick response (QR) code, digital identifier, etc.) configured to be scanned by a user device of authorized personnel to obtain current and past operational information for the ventilated workspace 100. The scannable code 230 may link users, for example via a mobile phone or other device, to operating data, performance history, service records, manuals, safety information, or real time monitoring data through local control systems, cloud databases, building systems, or remote servers.

In the illustrated embodiment, the scannable code 230 is located in the sash 118. However, in other embodiments, the scannable code 230 may be located on a portion of the cabinet 102, for example, on the front wall 114 or side walls 108, etc. Embodiments of the present invention are not limited to the scannable code 230 be located on the sash 118 or on any particular portion of the cabinet 102.

Types of operational information that may be obtained from scanning the scannable code 230 include, but is not limited to, one or more of the following: airflow/containment information (face velocity, exhaust flow, static pressure, alarm status), user behavior information (sash position, sash-open hours, movement events), environmental condition information (room pressure, temperature, cross-draft indicators), energy and equipment health information (fan/damper position, power and kWh, filter loading, fault codes), and administrative/safety records (certification results, tracer gas and ASHRAE 110 test data, airflow visualization notes, maintenance and calibration history). Such operational information may be obtained for various time periods, also. For example, time periods may include seconds-minutes for detailed test and alarm events, minutes-hours for individual experimental sessions, daily for usage and energy profiles, weekly-monthly for trends and early degradation detection, and annual for compliance, audits, and lifecycle planning, etc.

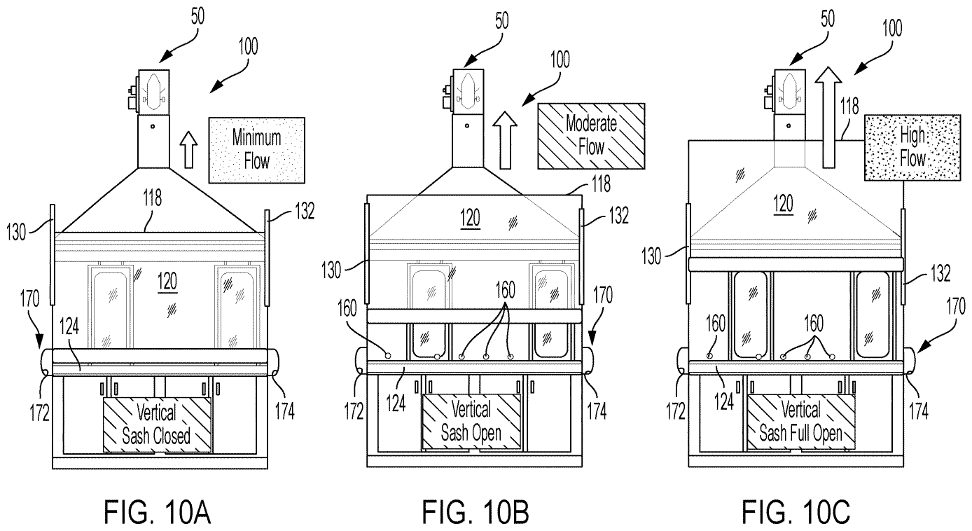

FIGS. 9A-9C and 10A-10C illustrate the impact of the vertical sash position on total exhaust flow. The ventilated workspace 100 may operate at multiple airflow levels based on sash position, opening area, sensed operating condition, contaminant level, or activity state. Lower sash openings may permit reduced exhaust flow, while larger openings or elevated demand conditions may trigger higher exhaust operation.

The combined features of the ventilated workspace 100 enable greater safety performance, reduced energy consumption, lower operating costs, and require fewer materials to construct than traditional fume hoods. The high-performance ventilated workspace 100 of the present invention does not rely on average face velocity like a traditional fume hood, rather containment performance is based on total exhaust flow. The total annual exhaust flow for a typical 6-ft high-performance ventilated workspace 100 according to an embodiment of the present invention would be approximately 200 cfm resulting in an annual cost of less than $1,000 per year at $5 per cfm-year. The novel design of the high-performance ventilated workspace 100 can reduce flow and energy consumption by approximately 30% over traditional fume hoods of similar size and application.

Key benefits of the ventilated workspace 100 according to embodiments of the present invention include:
1) Superior Hood Containment at all opening configurations (greater safety for workspace users and lab occupants).
2) Increased energy efficiency due to lower exhaust flow and hood static pressure (lower cost to operate).
3) Greater Flexibility for meeting Customer/User needs (greater utility for occupants).
4) Easier to Fabricate with Fewer Materials of Construction (simpler and lower cost to manufacture).
5) Easier Installation and enhanced ability to relocate (lower cost to install).
6) Self-Monitoring of Use and Operation (greater safety and reliability).
7) Virtual Monitor with Remote Access to Data (Better management with lower cost).
8) Integrated “occupied-in use”, and “unoccupied-not in use” operating modes (minimizes waste).

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity. The term “and/or” includes any and all combinations of one or more of the associated listed items.

Like numbers refer to like elements throughout. In the figures, certain components or features may be exaggerated for clarity, and broken lines may illustrate optional features or operations unless specified otherwise. In addition, the sequence of operations (or steps) is not limited to the order presented in the figures and/or claims unless specifically indicated otherwise. Features described with respect to one figure or embodiment can be associated with another embodiment or figure although not specifically described or shown as such.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected”, “coupled”, “responsive”, or variants thereof to another element, it can be directly connected, coupled or responsive to the other element or intervening elements may be present. In contrast, when an element is referred to as being “directly connected”, “directly coupled”, “directly responsive”, or variants thereof to another element, there are no intervening elements present. Other words used to describe the relationship between elements should be interpreted in a like fashion (i.e., “between” versus “directly between”, “adjacent” versus “directly adjacent”, etc.).

As used herein, the singular forms “a”, “an” and “the” are intended to include the plural forms as well, unless the context clearly indicates otherwise. As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.,” which derives from the Latin phrase “exempli gratia,” may be used to introduce or specify a general example or examples of a previously mentioned item, and is not intended to be limiting of such item. The common abbreviation “i.e.,” which derives from the Latin phrase “id est,” may be used to specify a particular item from a more general recitation.

It will be understood that although the terms first, second, third, etc., may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of the present invention. The same reference numerals or the same reference designators denote the same or similar elements throughout the specification.

Relative terms such as “below” or “above” or “upper” or “lower” or “horizontal” or “vertical” may be used herein to describe a relationship of one element, layer or region to another element, layer or region as illustrated in the figures.

The terms “about” and “approximately”, as used herein with respect to a value or number, is meant to encompass variations of ±10%, ±5%, ±1%, ±0.5%, or even ±0.1% of the specified value as well as the specified value. For example, “about X” where X is the measurable value, is meant to include X as well as variations of ±10%, ±5%, ±1%, ±0.5%, or even ±0.1% of X. A range provided herein for a measurable value may include any other range and/or individual value therein.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the teachings and advantages of this invention. Accordingly, all such modifications are intended to be included within the scope of this invention as defined in the claims. The invention is defined by the following claims, with equivalents of the claims to be included therein.

What is claimed is:

1. A ventilated workspace, comprising:
a cabinet comprising a rear wall, a front wall, a floor, and opposing side walls that define an internal chamber, wherein the front wall comprises a chamber access opening, wherein the rear wall and side walls each include a plurality of openings configured to permit airflow from an external environment into the chamber; and
an air duct externally mounted to the cabinet rear wall and side walls, wherein the air duct comprises a first open end portion and an opposite second open end portion, and wherein the air duct is in fluid communication with the plurality of openings in the rear wall and side walls such that air entering the first and second open end portions of the air duct can flow through the plurality of openings in the rear wall and side walls and into the chamber.

2. The ventilated workspace of claim 1, wherein the plurality of openings in the rear wall and side walls are in adjacent, spaced apart relationship.

3. The ventilated workspace of claim 1, wherein the air duct extends around the cabinet such that the first open end portion of the air duct is located adjacent to one side of the cabinet front wall and the opposite second open end portion of the air duct is located adjacent to an opposite side of the cabinet front wall.

4. The ventilated workspace of claim 1, further comprising an airflow monitor configured to measure an amount of airflow into the chamber.

5. The ventilated workspace of claim 1, further comprising a sash slidably mounted to the cabinet at the access opening and movable between raised and lowered positions along a non-vertical direction.

6. The ventilated workspace of claim 5, wherein the sash is located external to the cabinet.

7. The ventilated workspace of claim 5, further comprising at least one horizontally sliding panel at the access opening that is configured to cover and uncover portions of the access opening.

8. The ventilated workspace of claim 7, wherein at least a portion of the at least one horizontally sliding panel is transparent.

9. The ventilated workspace of claim 1, further comprising at least one service panel secured externally to the cabinet, wherein the service panel provides one or more of the following for the ventilated workspace: air supply from an air source, gas supply from a gas source, vacuum from a vacuum source, and electrical service from an electrical source.

10. The ventilated workspace of claim 9, wherein the at least one service panel is externally mounted to one of the side walls.

11. The ventilated workspace of claim 1, further comprising a monitor within the chamber that is configured to measure airflow and air pressure within the chamber.

12. The ventilated workspace of claim 1, wherein an upper portion of the chamber is configured to be connected to an exhaust system having a fan and an exhaust duct, and further comprising a sensor within the chamber that is configured to detect contaminants in air exiting the chamber through the exhaust system.

13. The ventilated workspace of claim 1, wherein an upper portion of the chamber is configured to be connected to an exhaust system having a fan and an exhaust duct, and further comprising airflow guide vanes within the chamber that are configured to facilitate vertical airflow from the chamber into the exhaust system.

14. The ventilated workspace of claim 1, wherein the chamber comprises at least one filter configured to capture contaminants from air flowing to the exhaust system.

15. The ventilated workspace of claim 1, wherein the cabinet comprises a scannable code configured to be scanned by a user device to obtain current and past operational information for the ventilated workspace, wherein the operational information includes one or more of the following: sash configuration information, information about a hazard within the chamber, surrounding room temperature, surrounding room pressure.

16. The ventilated workspace of claim 15, wherein the scannable code comprises a barcode or a quick response (QR) code.

17. The ventilated workspace of claim 5, further comprising a sash sensor configured to determine a current position of the sash.

18. The ventilated workspace of claim 7, further comprising a sash sensor configured to determine a current position of the at least one horizontally sliding panel.

19. A ventilated workspace, comprising:
a cabinet comprising a rear wall, a front wall, a floor, and opposing side walls that define an internal chamber, wherein the front wall comprises a chamber access opening, wherein the rear wall and side walls each include a plurality of openings configured to permit airflow from an external environment into the chamber;
an air duct externally mounted to the cabinet rear wall and side walls, wherein the air duct comprises a first open end portion and an opposite second open end portion, and wherein the air duct is in fluid communication with the plurality of openings in the rear wall and side walls such that air entering the first and second open end portions of the air duct can flow through the plurality of openings in the rear wall and side walls and into the chamber;
a sash slidably mounted to the cabinet at the access opening and movable between raised and lowered positions; and
at least one service panel secured externally to the cabinet, wherein the service panel provides one or more of the following for the ventilated workspace: air supply from an air source, gas supply from a gas source, vacuum from a vacuum source, and electrical service from an electrical source.

20. The ventilated workspace of claim 19, further comprising at least one horizontally sliding panel at the access opening that is configured to cover and uncover portions of the access opening.

21. The ventilated workspace of claim 19, wherein an upper portion of the chamber is configured to be connected to an exhaust system having a fan and an exhaust duct, and further comprising a sensor within the chamber that is configured to detect contaminants in air exiting the chamber through the exhaust system.

22. The ventilated workspace of claim 19, wherein an upper portion of the chamber is configured to be connected to an exhaust system having a fan and an exhaust duct, and further comprising airflow guide vanes within the chamber that are configured to facilitate vertical airflow from the chamber into the exhaust system.

23. The ventilated workspace of claim 19, wherein the chamber comprises at least one filter configured to capture contaminants from air flowing to the exhaust system.

24. The ventilated workspace of claim 19, wherein the cabinet comprises a scannable code configured to be scanned by a user device to obtain current and past operational information for the ventilated workspace, wherein the operational information includes one or more of the following: sash configuration information, information about a hazard within the chamber, surrounding room temperature, surrounding room pressure.

25. A ventilated workspace, comprising:
a cabinet comprising a rear wall, a front wall, a floor, and opposing side walls that define an internal chamber, wherein the front wall comprises a chamber access opening, wherein the rear wall and side walls each include a plurality of openings configured to permit airflow from an external environment into the chamber, wherein an upper portion of the chamber is configured to be connected to an exhaust system having a fan and an exhaust duct;
an air duct externally mounted to the cabinet rear wall and side walls, wherein the air duct comprises a first open end portion and an opposite second open end portion, and wherein the air duct is in fluid communication with the plurality of openings in the rear wall and side walls such that air entering the first and second open end portions of the air duct can flow through the plurality of openings in the rear wall and side walls and into the chamber;
a sash slidably mounted to the cabinet at the access opening and movable between raised and lowered positions; and
airflow guide vanes within the chamber that are configured to facilitate vertical airflow from the chamber into the exhaust system.

26. The ventilated workspace of claim 25, further comprising at least one horizontally sliding panel at the access opening that is configured to cover and uncover portions of the access opening.

27. The ventilated workspace of claim 25, further comprising at least one service panel secured externally to the cabinet, wherein the service panel provides one or more of the following for the ventilated workspace: air supply from an air source, gas supply from a gas source, vacuum from a vacuum source, and electrical service from an electrical source.

28. The ventilated workspace of claim 25, wherein an upper portion of the chamber is configured to be connected to an exhaust system having a fan and an exhaust duct, and further comprising a sensor within the chamber that is configured to detect contaminants in air exiting the chamber through the exhaust system.

29. The ventilated workspace of claim 25, wherein the chamber comprises at least one filter configured to capture contaminants from air flowing to the exhaust system.

30. The ventilated workspace of claim 25, wherein the cabinet comprises a scannable code configured to be scanned by a user device to obtain current and past operational information for the ventilated workspace, wherein the operational information includes one or more of the following: sash configuration information, information about a hazard within the chamber, surrounding room temperature, surrounding room pressure.
